(19) United States
(12) Patent Application Publication
(10) Pub. No.: US 2005/0089356 A1
(43) Pub. Date: Apr. 28, 2005

(54) NON-PUSH TYPE PUSH KEY FOR TELEPHONES AND COMPUTERS

(76) Inventor: Wei Jung-Tsung, Tainan (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/694,663

(22) Filed: Oct. 28, 2003

(51) Int. Cl. B41J 5/08

(52) U.S. Cl. 400/472

(57) ABSTRACT

A push key for telephones, mobile phones, calculators and computer sets is made of conductive or non-conductive materials. In preferred aspects, the push key has a depression at the center of the key and a touch spot at the middle of the depression. When an operator's finger touches lightly or comes near the push key or the touch spot, the push key senses the touch or approach and creates a specified signal to control the dialing of a number or other functional control to prevent poor connection of the push key. Every push key is ensured to create necessary signals while reducing wear and tear on the words or icons printed on the surface of the push key. Thus, the operating procedures for the operator are simplified.

### BACKGROUND OF THE INVENTION

1. Field of the Invention

The present invention relates to a non-push type of push key for telephones and computers, the push key being capable of achieving anticipated operating objectives by touch or approaching, so the operation is made easy and simple.

2. Description of the Prior Art

The push keys on conventional telephones, mobile phones and computers (shown in FIGS. 1, 2 and 3) are generally made of one of two types of materials and are flexible or rigid. There are a variety of installations and signal sending methods for the keys, including that shown in FIG. 4, wherein on a faceplate 1 is provided with keyholes 10 to accommodate the push keys, at a lower part of the key 2 is provided with a flexible pad unit 3 of a flexible arch 31, made of rubber material, each flexible arch 31 matching each key 2, designed inside each flexible arch 31 being a conductive unit 32, provided at a lower part of the pad 3 being a circuit board 4, on the circuit board 4 being etched with a touch claw 41 for activating purpose as shown in FIG. 5, so when the key 2 is pushed down, the flexible arch 31 of the pad 3 is pressed and deformed, so the touch claw 41 etched on the circuit board 4 and the conductive unit are conducted, thereby creating specified signals to control the dialing of numbers and other functions. Operation and control procedures for the foregoing structure are described as follows:
1. The user reaches out his/her finger and aim at the key 2.
2. Move the finger to touch the key 2.
3. The finger applies a force to push down the key 2 to a specified depth.
4. The finger retracts and releases the force.
5. The finger moves away from the key 2.

Therefore, in the operation of the key 2 as described above, the finger has to be aligned with the key 2 to apply a force, and though the force applied is not too heavy, it requires a certain force, or if the force is applied or the depth reached is not sufficient, the conductive unit 32 inside the pad unit 3 will not be able to touch the touch claw 42 on the circuit board 4, and as a result, no dialing or control of the signal will be performed; on the other side, when the force applied is too much, it will result in excessive wear on the key 2, or the creation of an instantaneous spark, thereby reducing the service life of the key 2; meanwhile, a bigger pressing force of the key 2 means a bigger friction force between the finger and the key 2, resulting in excessive wear and tear on the number, word, icon or sign printed on the surface of the key 2.

As shown in FIG. 6, since the key 2 is embedded in the keyhole 10 on the faceplate 1, to enable smooth movement of the key 2, generally the keyhole 10 is made slightly larger than the key 2, but it also results in inclination of the key 2 when the finger is pressing on a position other than the very center of the key 2, and then, the conductive unit 32 is not capable of maintaining proper parallel contact with the touch claw 41, resulting in poor connection and failure of connection with the touch claw 41, and failure of creating dialing or control signals.

### SUMMARY OF THE INVENTION

To make improvement on the foregoing shortcomings, including shortened service life, heavy force and failure of effective touch, as found in the conventional key structure, the present invention has presented a key that is made of one of two types of material, conductive or non-conductive, to enable direct contact of the key with a circuit on a circuit board, so designed that the key will be able to sense the movement of an operator's finger when it is in contact or approaching the key to a specified distance, so the key is capable of activating necessary dialing and sending of control signals, thereby the operation is made light, effortless, and capable of minimizing wear and tear on the word, icon or sign printed on the surface of the key, and completely preventing the occurrence of an inclined key and failure of activation of signals.

Secondly, a depression is provided at the center of the key, and optionally a protrusion at the center of the key, with a depression at the center of the protrusion, and a touch spot at the center of the depression, the touch spot being connected directly to a circuit on the circuit board, so the finger will not touch neighboring keys by mistake and create wrong signals.

Selectively, there is a flexible member provided at a lower part of the key to increase flexibility, comfort and a familiar sense of touch as found in traditional keys.

For a full understanding of the present invention, please refer to the following description of preferred embodiments and drawings.

### BRIEF DESCRIPTION OF THE DRAWINGS

FIG. 1 is a perspective view of a prior art of regular telephone keys.

FIG. 2 is a perspective view of a prior art of mobile phone keys.

FIG. 3 is a perspective view of a prior art of regular computer keys.

FIG. 4 is a sectional view of a prior art of a regular push key.

FIG. 5 is a schematic view of a prior art of a regular push key activating circuit board showing the distribution of circuits.

FIG. 6 is a schematic view of a prior art of a regular push key being pressed and inclined.

FIG. 7 is a sectional view of the present invention of push key.

FIG. 8 is a section view of a second embodiment of the present invention of push key.

FIG. 9 is a perspective view of a third embodiment of the present invention of push key.

FIG. 10 is a section view of the third embodiment of the present invention of push key.

FIG. 11 is a perspective view of a fourth embodiment of the present invention of push key.

FIG. 12 is a section view of the fourth embodiment of the present invention of push key.

FIG. 13 is a section view of a fifth embodiment of the present invention of push key.

FIG. 14 is a perspective view of a sixth embodiment of the present invention of push key.

FIG. 15 is a section view of the sixth embodiment of the present invention of push key.

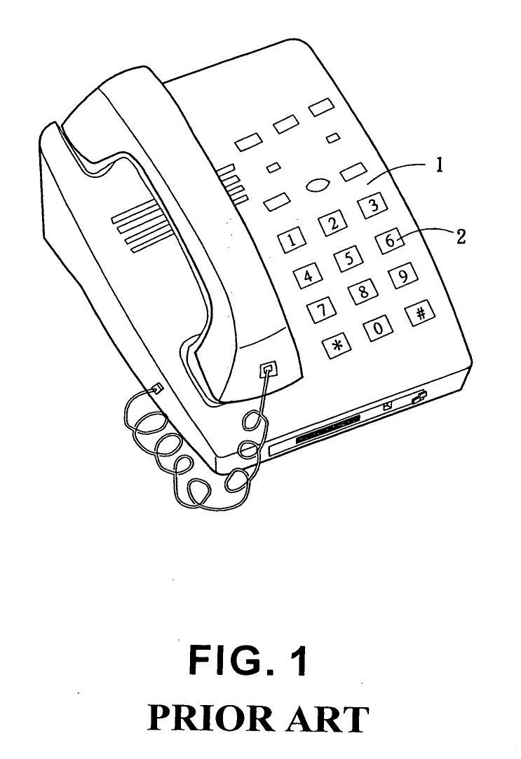

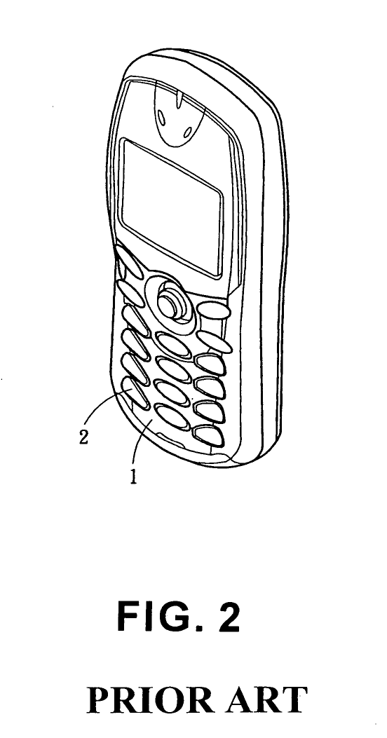

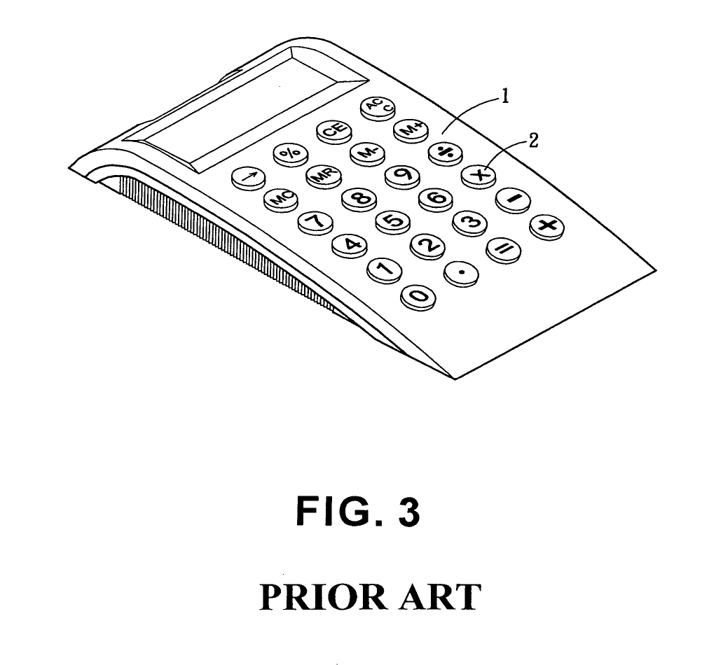

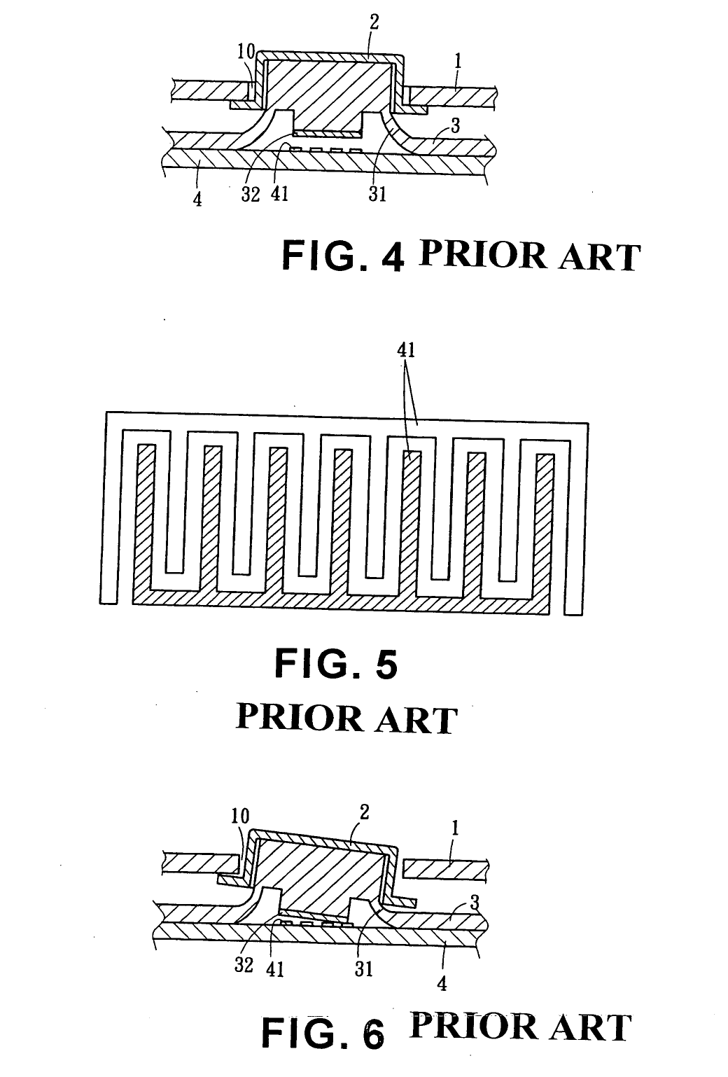

### BRIEF DESCRIPTION OF THE NUMERALS

5 faceplate 50 keyhole
6 key body 61 depression
62 touch spot 63 protrusion
7 circuit board 8 flexible member

### DETAILED DESCRIPTION OF PREFERRED EMBODIMENTS

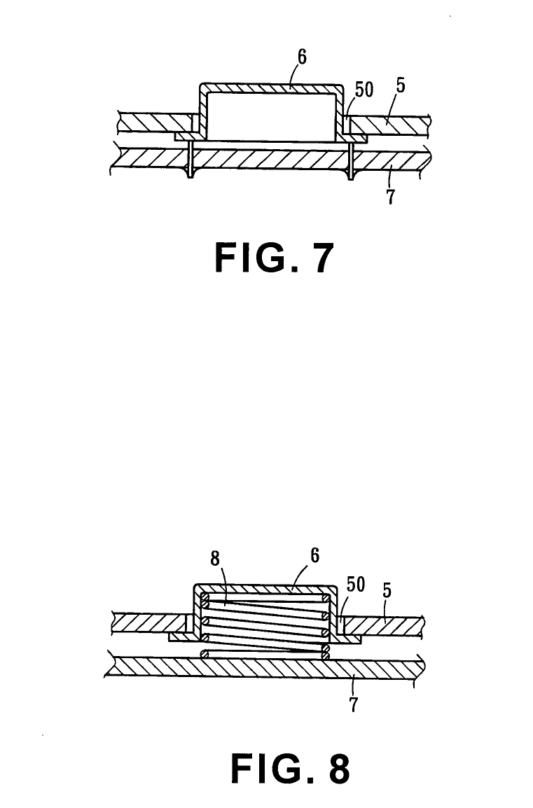

Please refer to FIG. 7 that shows the present invention as it is installed in a push key mechanism of a telephone, mobile phone and computer set, wherein, a specified number of keyholes 50 are designed on a faceplate 5 to accommodate a specified number of key bodies 6. Below the push key body 6 is installed a circuit board 7. On the circuit board 7 is installed electrostatic or capacitor type sensing and activating circuits. These sensing circuits serve to generate touch activated dialing numbers or control signals. A lower end of the key body 6 is connected to a sensing circuit. When an operator's finger lightly touches the key body 6 and the key body 6 receives and senses the touch, a dialing or control signal is created. Optionally, when the operator's finger comes near the key body 6, the key body 6 will accept and sense the approach and create necessary dialing or control signals. Operating procedures are briefly described as follows:
1. The user extends and aims his or her finger at the key body 6.
2. The user moves his or her finger to touch or approach the key body 6.
3. The user moves his or her finger away from the key body 6.

Therefore, the simple, easy and effortless operation will achieve the purposes of dialing or control.

Secondly, due to the very light touch or lack of touch (by approaching the key body 6 without touching it) of the user's finger, wear and tear on the surface of the key body 6 is minimized, and the wear and tear of the printed words, patterns or signs on the surface of the key body 6 is also minimized. By such operation of light touch or approach, the key will not be inclined and result in failure of activating the signals; there is no spark generated by touching, thereby the service life of the key body 6 is maximized.

As shown in FIG. 8, there is a flexible member 8 installed between a lower part of the key body 6 and the circuit board 7, providing flexibility to the key body 6, meanwhile, the key body 6 is connected through the flexible member 8 to the circuit board 7, therefore the key body 6 has a traditional sense of key touch in addition to a sensing and touch control capability.

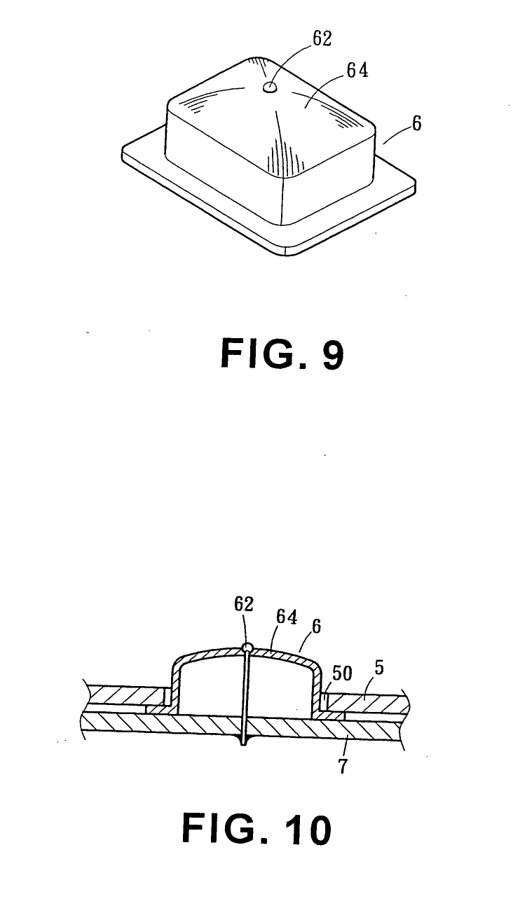

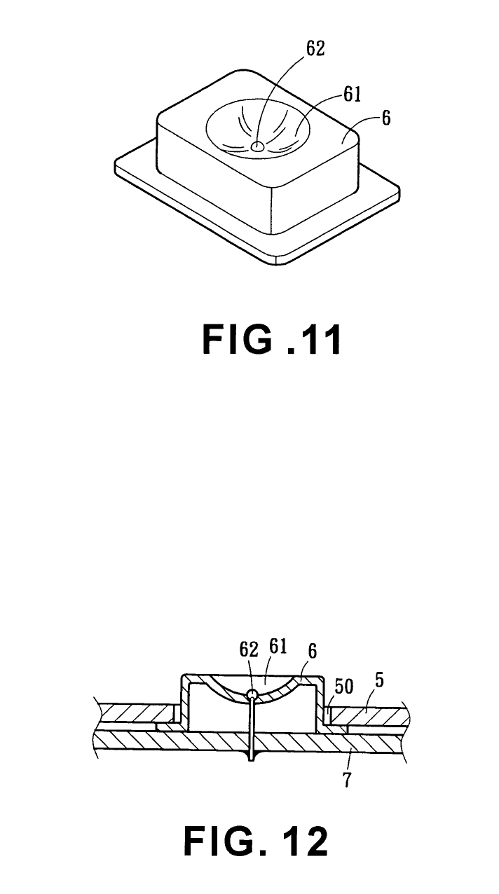

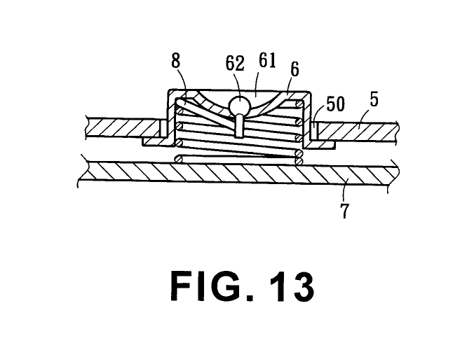

As shown in FIGS. 9 and 10, which show a perspective view and a section view of a third embodiment of the key body 6, involving an arched protrusion on a top of the key body 6. There is a touch spot 62 in the middle of the arched protrusion. The touch spot is connected to the sensing and touch-off circuit on the circuit board 7. The key body 6 itself has no sensing performance, but the touch spot 62 has a sensing effect. The objective is to enable sensing and activating of the circuit to dial or control only when the user's finger is in touch with or approaching the touch spot 62. FIGS. 11 and 12 show a perspective view and a section view of a fourth embodiment of the key body 6, involving a depression 61 at the middle of the key body 6, with a touch spot 62 designed at a lowest point in the middle of the depression 61, then the touch spot 62 is connected to the sensing and activating circuit of the circuit board 7, so the key body 6 itself has no sensing function, only the touch spot 62 has a sensing effect, for the purpose that, when the operator is operating the keys, the operator's finger muscle must be aligned with and lightly pressing the key body 6, so the operator's finger muscle can reach into the depression 61 to touch the touch spot 62 or come to a specified distance from the touch spot 62, in order to activate the circuit to dial or control, the objective is to prevent unwanted touch between the operator's other fingers or other parts of his/her palm and another key body 6 that may result in unwanted transmission of signals. FIG. 13 shows the mechanism of the touch spot 62 on the key body 6, with the flexible member 8 installed between the circuit board 7 and a lower part of the key body 6, the touch spot 62 being connected through the flexible member 8 to the sensing circuit, providing the key body 6 with the familiar flexible touch on a traditional keyboard.

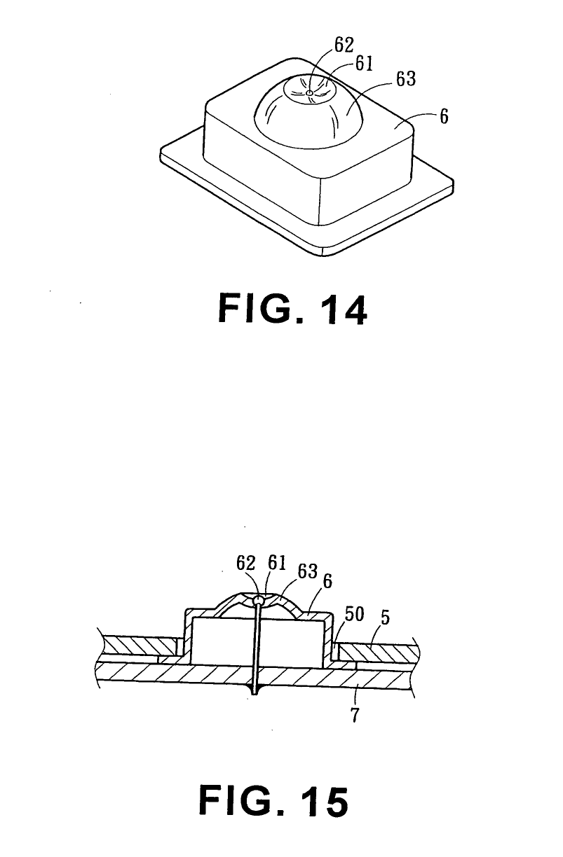

Please refer to FIGS. 14 and 15 that show a sixth embodiment, wherein a protrusion 63 is designed at the middle of the key body 6, with a depression 61 at the center of the protrusion 63, and a touch spot 62 at a lowest level in the center of the depression 61, and similarly, the touch spot 62 is connected to a sensing and activating circuit on the circuit board 7. Thereby, the key body 6 itself does not have a sensing function, but only the touch spot 62 has a sensing effect, the purpose and operation are the same as described for the third embodiment. Optionally, as in the fifth embodiment, there is a flexible member 8 installed between the circuit board 7 and a lower part of the key body 6, providing a familiar sense of touch to the key body 6 as found in the conventional keys.

Features of the present invention include the following:
1. Simplified operation procedures and steps.
2. No failure of connection will happen to the push keys.
3. Significant reduction of wear and tear on the icons printed on the keys.
4. Reservation of familiar touch of traditional keys, providing familiarity to the operator.
5. Equipped with prevention against unwanted touch and activation.

Though the above disclosure and description of the embodiments of the present invention are clearly understandable to people skilled in the art, it is to be understood that all shape variations and regional modifications shall be included in the spirit and intent of the present invention.

1. A push key assembly for telephones, mobile phones and computer sets, comprising a plurality of keyholes on a faceplate; a plurality of push keys in the keyholes; and a circuit board installed below the push keys and having an electrostatic or capacitor type sensing and activating circuit, with the push keys being connected to the electrostatic or capacitor type sensing and activating circuit of the circuit board, with the push keys being activated by contact and approaching of an operator's finger.

2. The push key assembly of claim 1, further comprising a flexible member between each push key and the circuit board pushing the push key upward and providing the push key with flexibility, with the push key being connected to the electrostatic or capacitive type activation circuit by the flexible member.

3. The push key assembly of claim 1, wherein at a top side of each of the push keys is provided an arched protrusion, and on the arched protrusion being a touch spot, with the touch spot being connected to the electrostatic or capacitive type sensing and activating circuit of the circuit board.

4. The push key assembly of claim 1, wherein a center of each of the push keys being provided with a depression and at a center of the depression being a touch spot, with the touch spot connected to the electrostatic or capacitive sensing and activating circuit of the circuit board.

5. The push key assembly of claim 1, further comprising a protrusion at a center of each of the push keys; a depression at the center of the protrusion; and a touch spot slightly protruded from a center of the depression, with the touch spot being connected to the electrostatic or capacitor type sensing and activating circuit of the circuit board.

6. The push key assembly of claim 4, further comprising a flexible member between each push key and the circuit board pushing the push key upward and providing the push key with flexibility, with the push key being connected to the electrostatic or capacitive type activation circuit by the flexible member.
